(19) United States
(12) Patent Application Publication
(10) Pub. No.: US 2018/0123501 A1
(43) Pub. Date: May 3, 2018

(54) MOTOR-DRIVEN APPARATUS AND CONTROL METHOD THEREOF

(71) Applicant: Johnson Electric S.A., Murten (CH)

(72) Inventors: Youqing XIANG, Shenzhen (CN); Shiwen WANG, Shenzhen (CN); Wufeng QIU, Shenzhen (CN); Lianzhong ZHANG, Shenzhen (CN); Xiyi HU, Shenzhen (CN)

(21) Appl. No.: 15/801,613

(22) Filed: Nov. 2, 2017

(30) Foreign Application Priority Data
Nov. 2, 2016 (CN) 2016 1094 9925.X

(51) Int. Cl. H02P 29/40; H02P 6/28; A47J 43/046; A47J 43/07

(52) U.S. Cl. CPC H02P 29/40; A47J 43/0716; A47J 43/046; H02P 6/28

(57) ABSTRACT

A motor-driven apparatus comprises a motor, a heating subcircuit and a motor controlling subcircuit connected in parallel between two ends of an alternating current power supply. When the heating subcircuit operates, a power of the motor is adjusted according to an operating state of the heating subcircuit so that a total operation current flowing through a main line is less than a predetermined value.

### CROSS REFERENCE TO RELATED APPLICATIONS

This non-provisional patent application claims priority under 35 U.S.C. §119(a) from Patent Application No. 201610949925.X filed in the People's Republic of China on Nov. 2, 2016.

### TECHNICAL FIELD

The present disclosure relates to a motor-driven apparatus and a control method thereof, in particular to a technique for adjusting a total operation current of the motor-driven apparatus.

### BACKGROUND

A food processor, such as a juicer and a food cooking machine, is a motor application apparatus often used in people's daily life. A food processor includes a motor, a bowl, a heating component and so on. The motor drives a cutting tool to rotate at a high speed and cut the food. The heating component may heat the food when needed. Generally, a total operation current Itotal flowing through a main line of the power supply in the food processor is less than a predetermined value, to meet corresponding industry security standards or user's security requirements. The conventional food processor can meet the requirement that the total operation current Itotal is less than the predetermined value, when a cutting operation via the motor and a heating operation are performed separately. However, when the cutting operation and the heating operating are simultaneously performed, a sum of a current Iheater of the heating subcircuit and a current Idrive of the motor controlling subcircuit may be larger than the predetermined value of the total operation current Itotal. Currently, the total operation current is controlled by adjusting the heating subcircuit, for example, controlling the on/off states of the heating component by stages to decrease an average power of the heating component, so as to decrease an average current Iheater of the heating subcircuit, thereby decreasing the average value of the total operation current Itotal. However, a peak of the total current is much larger than the predetermined value, thus security risks or over-current protection of user's power supply circuits are generated, as shown in FIG. 1. Another method is to control a conduction angle of the heating component in the heating subcircuit, a conduction duration is decreased, so as to decrease the current Iheater of the heating subcircuit, thereby decreasing the total operation current Itotal. However, this method may generate harmonic wave as shown in FIG. 2 and FIG. 3, both of which are oscillograms of the total operation currents Itotal corresponding to different conduction angles in the heating subcircuit. The generation of harmonic wave results in electromagnetic compatibility (EMC) problems of the food processor.

### SUMMARY

In view of the above, a motor-driven apparatus and a control method thereof is in demand to address the above issues.

A motor-driven apparatus comprises a motor, a heating subcircuit and a motor controlling subcircuit connected in parallel between two ends of an alternating current power supply. When the heating subcircuit operates, a power of the motor is adjusted according to an operating state of the heating subcircuit so that a total operation current flowing through a main line is less than a predetermined value.

Preferably, the motor controlling subcircuit comprises a first microprocessor to control the motor.

Preferably, the heating subcircuit comprises a heating component with at least one heating level.

Preferably, the power of the motor is adjusted by adjusting a pulse width modulation signal transmitted to the motor according to the heating level of the heating component.

Preferably, the power of the motor is adjusted by adjusting a duty ratio of the pulse width modulation signal.

Preferably, the heating subcircuit comprises a heating level selection unit, the heating component and a controllable bidirectional AC switch connected to each other in series, and the heating subcircuit further comprises a second microprocessor connecting to the heating level selection unit and a control end of the controllable bidirectional AC switch, and the second microprocessor controls the heating level selection unit according to an operation instruction to make the heating component operate at a corresponding heating level.

Preferably, the first microprocessor is connected to the second microprocessor and the second microprocessor transmits the operating state of the heating subcircuit to the first microprocessor.

Preferably, the motor-driven apparatus is a food processor, and/or the motor is a three-phase brushless direct current motor.

A control method of the motor-driven apparatus described in any above solution is provided according to an embodiment of the present disclosure, including: determining whether the heating subcircuit needed to operate; and adjusting the power of the motor according to the operating state of the heating subcircuit when the heating subcircuit is needed to operate, the total operation current flowing through the main line made less than the predetermined value.

Preferably, determining whether the heating subcircuit is needed to operate or not according to the operation instruction.

Preferably, when the heating subcircuit is needed to operate, the heating level of the heating component is determined, and the power of the motor is adjusted by adjusting the pulse width modulation signal outputted to the motor according to the heating level of the heating component.

Preferably, when the heating subcircuit does not need to operate, the power of the motor is not adjusted according to the operating state of the heating subcircuit.

The motor-driven apparatus and the current adjusting method thereof, provided according to embodiments of the present disclosure, the power of the motor is adjusted during heating time of the heating component, so that the total operation current of the motor-driven apparatus is smaller than the predetermined value. And the total operation current is basically a smooth sinusoidal wave, reducing current spikes and current harmonics.

### BRIEF DESCRIPTION OF THE DRAWINGS

FIG. 1 is an oscillogram of a total operation current which is adjusted by controlling on/off states of a heating component by stages.

FIG. 2 and FIG. 3 are oscillograms of total operation currents which are adjusted by controlling a conduction angle of a heating subcircuit.

FIG. 4 is a schematic diagram of a food processor according to one embodiment of the present disclosure.

FIG. 5 is a schematic diagram of a drive circuit in a food processor according to one embodiment of the present disclosure.

FIG. 6 is a schematic flowchart of a control method for controlling a food processor.

FIG. 7 is a graph of characteristic curves of speed, torque and power of a motor under the control method of FIG. 6.

FIG. 8 is an oscillogram of a total operation current under a control method of FIG. 6.

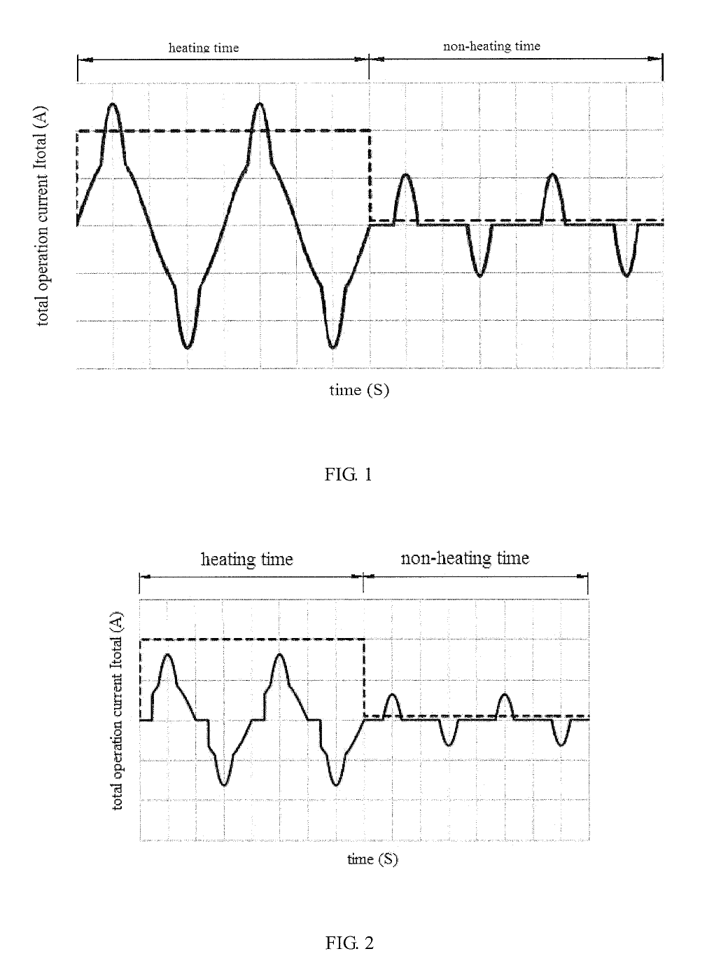

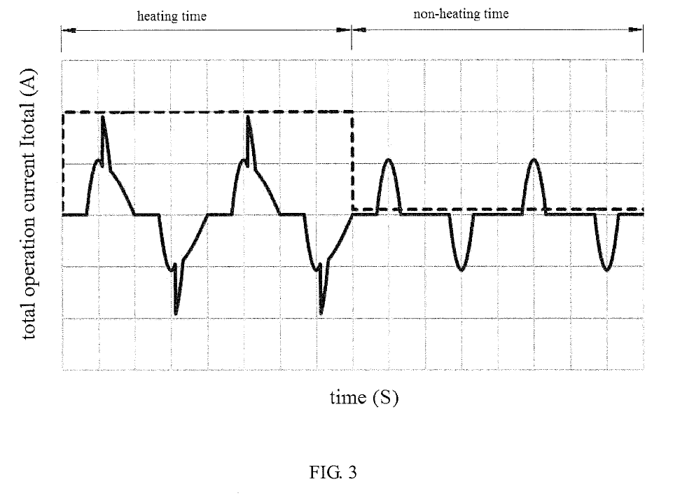

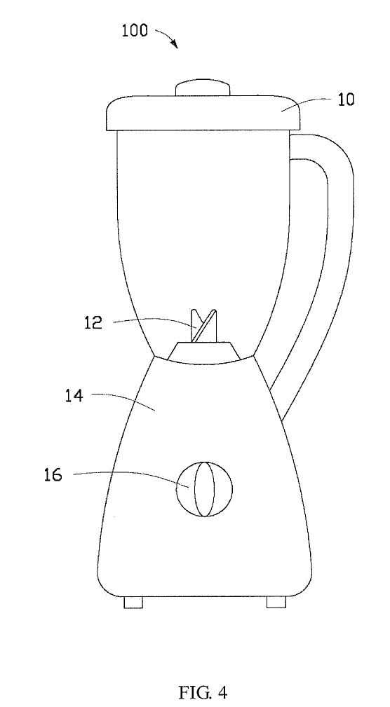

The following implementations are used for the description of the present disclosure in conjunction with above FIGs.

### DETAILED DESCRIPTION OF THE EMBODIMENTS

Hereinafter technical solutions in embodiments of the present disclosure are described clearly and completely in conjunction with the drawings in embodiments of the present disclosure. Apparently, the described embodiments are only some rather than all of the embodiments of the present disclosure. Any other embodiments obtained based on the embodiments of the present disclosure by those skilled in the art without any creative work fall within the scope of protection of the present disclosure. It is understood that, the drawings are only intended to provide reference and illustration, and not to limit the present disclosure. The connections in the drawings are only intended for the clearance of description, and not to limit the type of connections.

It should be noted that, if a component is described to be “connected” to another component, it may be connected to another component directly, or there may be an intervening component simultaneously. All the technical and scientific terms in the present disclosure have the same definitions as the general understanding of those skilled in the art, unless otherwise defined. Herein the terms in the present disclosure are only intended to describe embodiments, and not to limit the present disclosure.

FIG. 4 shows a motor-driven apparatus, such as a food processor 100, according to one embodiment of the present disclosure. The food processor 100 includes a bowl 10, a cutting tool 12, a base 14 and a switch 16. The bowl 10 is arranged on the base 14 in which a motor 120 and a drive circuit for the food processor are provided. An output shaft of the motor 120 extends into the bowl 10. The cutting tool 12 is arranged on the output shaft of the motor 120. According to applications of the food processor, the cutting tool 12 may include a slice cutting tool, a hole cutting tool, a reamer, a cross-blade, a noodle chopper, a blender and so on. The switch 16 has various functions, such as a low speed function, a medium speed function, a high speed function, a stop function, and a heating function, to control the food processor to operate in different modes.

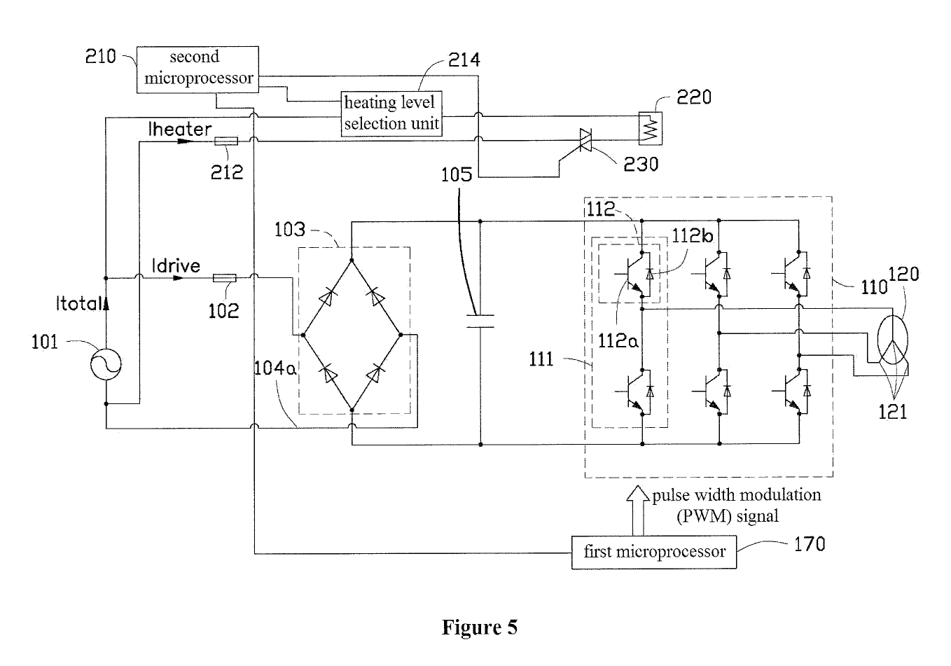

FIG. 5 is a schematic diagram of a drive circuit in the food processor 100 according to one embodiment of the present disclosure. As shown in FIG. 5, the drive circuit of the food processor 100 includes a motor controlling subcircuit and a heating subcircuit, connected in parallel between two ends of an alternating current power supply 101.

The motor controlling subcircuit can include the motor 120, an inverter 110, a first microprocessor 170, an AC-DC converter 103, a first fuse 102 and a capacitor 105. Preferably, the alternating current power supply 101 is an alternating current mains supply with a fixed frequency such as 50 Hz or 60 Hz. The voltage of the alternating current power supply 101 may be 110V, 220V, 230V and so on. The AC-DC converter 103 is configured to rectify an alternating current from the alternating current power supply 101 into a direct current, and may be a bridge rectifier composed of diodes. The capacitor 105 is connected between two output ends of the AC-DC converter 103. The inverter 110 is connected between the two output ends of the AC-DC converter 103, and is configured to convert the direct current into a three-phase alternating current. In the implementation, the inverter 110 is a three-phase bridge inverter, and is configured to convert the direct current from the AC-DC converter 103 into a three-phase alternating current with various frequencies. The inverter 110 includes three inverting circuits 111, each connected in parallel with the capacitor 105 respectively. Each inverting circuit 111 includes two inverting components 112 connected in series and an output end. The output end is connected between the two inverting components 112. Each inverting component 122 includes a transistor 122a and a diode 112b connected to each other in parallel. Each of the three-phase alternating current access ends 121 of the motor 120 is connected to the output end of a respective inverting circuit 111, so that the motor 120 receives the three-phase alternating current from the inverter 110. The first microprocessor 170 outputs a pulse width modulation (PWM) signal, according to a magnet pole position of the rotor of the motor 120, to control the on/off state of each inverting component 112 of the inverter 110, so as to control a commutation of current in the motor 120 and drive the motor 120. The motor 120 drives the cutting tool to rotate and cut foods. In the embodiment, the motor 120 may be a brushless direct current (BLDC) motor. The first fuse 102 is connected between the alternating current power supply 101 and the AC-DC converter 103. In case of a circuit malfunction such as short circuit or overcurrent, the first fuse 102 is blown to protect the food processor 100. As shown in FIG. 5, a current flowing through the first fuse 102 is denoted as Idrive, that is, a drive current of the motor controlling subcircuit. In the embodiment, a maximum value of the drive current Idrive is 12 A when the motor 120 operates individually.

The heating subcircuit includes a second microprocessor 210, and a second fuse 212, a controllable bidirectional AC switch 230 and a heating component 220. The second microprocessor 210, the second fuse 212, the controllable bidirectional alternating current switch 230 and the heating component 220 are connected in series between two ends of the alternating current power supply. The second microprocessor 210 is connected to a control end of the controllable bidirectional AC switch 230 to control an operation state of the controllable bidirectional AC switch 230. When the heating component 220 is needed to operate, the second microprocessor 210 sends a trigger signal to turn on the controllable bidirectional AC switch 230. When the heating component 220 is not needed to operate, the second microprocessor 210 does not send the trigger signal to the controllable bidirectional AC switch 230 to disconnect the heating subcircuit. As shown in FIG. 4, a current flowing through the fuse 212 is denoted as a heating current Iheater.

The heating component 220 in the heating subcircuit may include a fixed heating level or a plurality of adjustable heating levels. For the fixed heating level, the heating component 220 provides only one fixed power. For the adjustable heating levels, the heating subcircuit further includes a heating level selection unit 214, which is connected between the two ends of the alternating current power supply and connected in series with the fuse 212, the controllable bidirectional alternating current switch 230 and the heating component 220. The heating level selection unit 214 is further connected to the second microprocessor 210. The heating level selection unit 214 is controlled by the second microprocessor 210 to enable the heating component 220 to provide various heating levels to heat foods in the bowl 10. In the embodiment, the heating component 220 can include two heating levels, namely, level 1 and level 2. The heating component 220 operates at level 1 has a higher power than it operates at level 2. The second microprocessor 210 controls an operating state of the heating component 220 according to operation instructions inputted by a user. The heating component 220 may be a heating coil. The heating current Iheater is 10 A when the heating component 220 operates at level 1. The heating current Iheater is 8 A when the heating component operates at level 2.

The second microprocessor 210 is further connected to the first microprocessor 170, so as to send the operating state of the heating component 220 to the first microprocessor 170.

Each of the heating subcircuit and the motor controlling subcircuit forms a loop with the main line. The current of the main line is denoted as a total operation current Itotal, that is, a current flowing through the alternating current power supply 101. In security standards for the field of food processing machines or in security requirements by various users for food processing machines, the total operation current is generally required to be less than a predetermined value such as 15 A. It should be understood that when only one of the heating subcircuit and the motor controlling subcircuit operates, the total operation current Itotal is always less than the predetermined value 15 A. However, when the heating subcircuit and the motor controlling subcircuit operate simultaneously, e.g., the food processor 100 performs cutting and heating simultaneously, the total operation current Itotal flowing through the main line may exceed 15 A, which does not meet security standards.

The second microprocessor 210 can receive the operation instructions to control the food processor 100. The operation instructions can include whether to heat, the heating level, and heating time. The operation instructions can be set through the switch 16. For example, the user may set the heating subcircuit operates at level 1 for two minutes via the switch 16. The second microprocessor 210 controls operating states of the heating level selection unit 214 and the controllable bidirectional AC switch 230 based on the heating instructions. Meanwhile, the second microprocessor 210 sends the user's operation instructions to the first microprocessor 170, so that the first microprocessor 170 is informed of the operating states of the heating subcircuit to adjust the power of the motor according to the operating states in order that the total operation current Itotal is less than the predetermined value.

In the embodiment, the power of the motor may be adjusted by adjusting a duty ratio of the pulse width modulation signal sent to the motor. For example, when the heating subcircuit operates at level 1, the power of the motor is adjusted to 40% of a maximum output power of the motor by the first microprocessor 170. The current Idrive of the motor controlling subcircuit will decrease so that the total operation current is less than the predetermined value. The output power of the motor under a predetermined rotation speed is approximately proportional to the current inputted by the motor controlling subcircuit in case of little fluctuations in efficiency of a load point. when the heating subcircuit operates at level 2, due to the decrease of the current of the heating subcircuit relative to level 1, the power of the motor is adjusted by the first microprocessor 170 to a power higher than the power at level 1, that is, 60% of the maximum output power of the motor, and the total operation current is less than the predetermined value.

During a heating time in which the heating subcircuit operates, the first microprocessor 170 adjusts the power of the motor according to the heating level of the heating subcircuit. During a non-heating time in which the heating subcircuit does not operate, the first microprocessor 170 controls the motor according to a rotation speed level set by a user, without influence of the heating subcircuit. when there is only one fixed heating level for the food processor 100, the first microprocessor 170 adjusts the power of the motor according to a predetermined value, during the heating time in which the heating subcircuit operates.

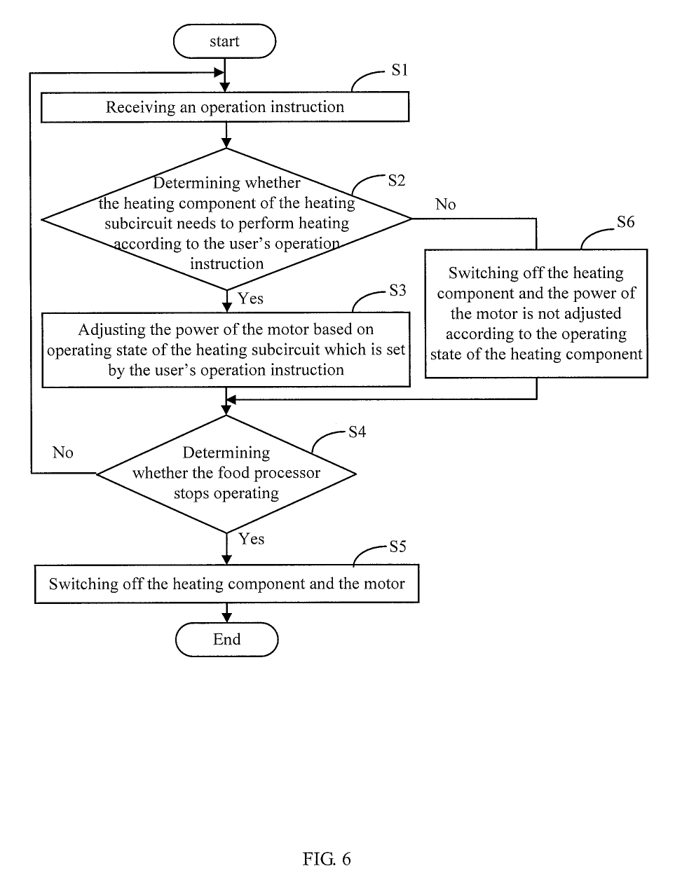

Reference is made to FIG. 6, which is a flowchart of a control method for a motor-driven apparatus such as the food processor 100 according to the present disclosure. The control method includes steps S1 to S6.

In step S1, an operation instruction inputted by a user is received, where the user's operation instruction may control the motor to rotate at a low speed level, a medium speed level, or a high speed level, to rotate while heating, or to heat only. And the user may set the heating time and a rotating time of the motor.

In step S2, determining whether the heating component of the heating subcircuit needs to perform heating according to the user's operation instruction. Step S3 is performed when the heating component is needed to perform heating; step S6 is performed when the heating component isn't needed to perform heating.

In step S3, the heating component is controlled to perform heating, and the power of the motor is adjusted based on operating state of the heating subcircuit which is set by the user's operation instruction. The total operation current is less than the predetermined value. when there is only one heating level for the food processor, the power of the motor is adjusted according to the predetermined value during the heating time in which the heating subcircuit operates. when there are two or more heating levels for the food processor, this step further includes determining which operating level the heating subcircuit is set by the user, and then adjusting the power of the motor according to the operating state of the heating subcircuit.

In step S4, determining whether the food processor stops operating. When the food processor stops, the step S5 is performed; when the food processor does not stop, step S1 is performed.

In step S5, the heating component and the motor are switched off.

In step S6, the heating component is switched off, and the power of the motor is not adjusted according to the operating state of the heating subcircuit. The motor is controlled according to the operation instruction inputted by the user in step S1.

It should be noted that, the steps shown in FIG. 6 may not be performed in the sequence as listed in the FIG., and two sequential listed steps, such as step S1 and S2, may be performed basically simultaneously. Two adjacent listed steps may not be performed sequentially, between which other operations may be performed. The listed implementation is only intended for an example, not to limit the present disclosure.

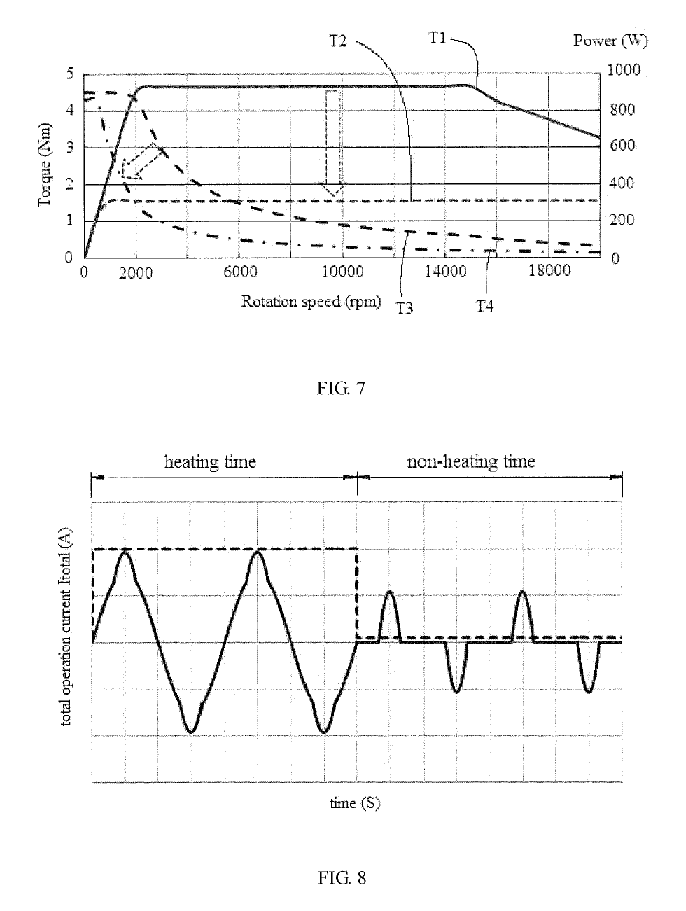

Referring to FIG. 7 and FIG. 8. FIG. 7 is a graph of characteristic curves of speed, torque and power of a motor under a control method according to an embodiment of the present disclosure. Curve T1 is a maximum output power curve of the motor, and curve T2 is a power curve when the output power of the motor is 40% of the maximum output power. Curve T3 is a maximum output torque curve of the motor, and curve T4 is an output torque curve when the output power of the motor is 40% of the maximum output power. FIG. 8 is an oscillogram of the total operation current Itotal of a control method according to an embodiment of the present disclosure. As shown in FIG. 7 and FIG. 8, when the output power of the motor is adjusted to 40% of the maximum output power of the motor, the output torque of the motor decreases relative to the maximum torque of the motor. Under a certain rotation speed, the output torque or output power of the motor is proportional to the current inputted by the motor controlling subcircuit, assuming that efficiencies of the motor and the drive circuit thereof are constant. Accordingly, the current Idrive of the motor controlling subcircuit decreases relative to the maximum current 12 A, and in the embodiment the current Idrive is less than 5 A. Thus the total operation current Itotal is less than the predetermined value 15 A as Idrive is added to the heating current Iheater, such as 10 A, so as to meet industry security standards or user's requirements. As shown in FIG. 8, during the heating time of the food processor, the power of the motor controlling subcircuit is adjusted and hence the total operation current Itotal is basically a smooth sinusoidal wave, current spikes and current harmonics are reduced.

In summary, in the current adjusting method according to an embodiment of the present disclosure, during the heating time of the heating component, the power of the motor in the motor controlling subcircuit is adjusted to reduce current spikes and current harmonics and optimize an electromagnetic compatibility (EMC) property of the product.

Described above are preferable embodiments of the present disclosure, which are not intended to limit the present disclosure. All the modifications, equivalent replacements and improvements in the scope of the spirit and principles of the present disclosure are in the protection scope of the present disclosure.

1. A motor-driven apparatus, comprising:
a motor;
a heating subcircuit;
a motor controlling subcircuit connected in parallel with the heating subcircuit between two ends of an alternating current power supply;
wherein when the heating subcircuit operates, a power of the motor is adjusted according to an operating state of the heating subcircuit to make a total operation current flowing through a main line of the motor-driven apparatus is less than a predetermined value.

2. The motor-driven apparatus of claim 1, wherein the motor controlling subcircuit comprises a first microprocessor to control the motor.

3. The motor-driven apparatus of claim 2, wherein the heating subcircuit comprises a heating component with at least one heating level.

4. The motor-driven apparatus of claim 3, wherein the power of the motor is adjusted by adjusting a pulse width modulation signal transmitted to the motor according to the heating level of the heating component.

5. The motor-driven apparatus of claim 4, wherein the power of the motor is adjusted by adjusting a duty ratio of the pulse width modulation signal.

6. The motor-driven apparatus of claim 3, wherein the heating subcircuit comprises a heating level selection unit, the heating component and a controllable bidirectional AC switch connected to each other in series, and the heating subcircuit further comprises a second microprocessor connecting to the heating level selection unit and a control end of the controllable bidirectional AC switch, and the second microprocessor controls the heating level selection unit according to an operation instruction to make the heating component operate at a corresponding heating level.

7. The motor-driven apparatus of claim 6, wherein the first microprocessor is connected to the second microprocessor and the second microprocessor transmits the operating state of the heating subcircuit to the first microprocessor.

8. The motor-driven apparatus of claim 1, wherein the motor-driven apparatus is a food processor, and/or the motor is a three-phase brushless direct current motor.

9. A control method of the motor-driven apparatus of claim 1, comprising:
determining whether the heating subcircuit needed to operate; and
adjusting the power of the motor according to the operating state of the heating subcircuit when the heating subcircuit is needed to operate, the total operation current flowing through the main line made less than the predetermined value.

10. The control method of the motor-driven apparatus of claim 9, wherein determining whether the heating subcircuit is needed to operate according to the operation instruction.

11. The control method of the motor-driven apparatus of claim 9, wherein when the heating subcircuit is needed to operate, a heating level of the heating component is determined, and the power of the motor is adjusted by adjusting the pulse width modulation signal outputted to the motor according to the heating level of the heating component.

12. The control method of the motor-driven apparatus of claim 10, wherein when the heating subcircuit is not needed to operate, the power of the motor is not adjusted according to the operating state of the heating subcircuit.

13. A motor-driven apparatus, comprising:
a motor;
a heating subcircuit;
a motor controlling subcircuit connected in parallel with the heating subcircuit;
wherein when the heating subcircuit is operated, a power of the motor is adjusted according to an operating state of the heating subcircuit to make a total operation current flowing through a main line of the motor-driven apparatus is less than a predetermined value.

14. The motor-driven apparatus of claim 13, wherein the motor controlling subcircuit comprises a first microprocessor to control the motor.

15. The motor-driven apparatus of claim 14, wherein the heating subcircuit comprises a heating component with at least one heating level.

16. The motor-driven apparatus of claim 15, wherein the power of the motor is adjusted by adjusting a pulse width modulation signal transmitted to the motor according to the heating level of the heating component.

17. The motor-driven apparatus of claim 16, wherein the power of the motor is adjusted by adjusting a duty ratio of the pulse width modulation signal.

18. The motor-driven apparatus of claim 15, wherein the heating subcircuit comprises a heating level selection unit, the heating component and a controllable bidirectional AC switch connected to each other in series, and the heating subcircuit further comprises a second microprocessor connecting to the heating level selection unit and a control end of the controllable bidirectional AC switch, and the second microprocessor controls the heating level selection unit according to an operation instruction to make the heating component operate at a corresponding heating level.

19. The motor-driven apparatus of claim 18, wherein the first microprocessor is connected to the second microprocessor and the second microprocessor transmits the operating state of the heating subcircuit to the first microprocessor.

20. The motor-driven apparatus of claim 13, wherein the motor-driven apparatus is a food processor, and/or the motor is a three-phase brushless direct current motor.
